(19) United States
(12) Patent Application Publication
(10) Pub. No.: US 2026/0212149 A1
(43) Pub. Date: Jul. 23, 2026

(54) PRE-LAMINATED STRUCTURE FOR A SMART CARD AND/OR FOR A DATA PAGE FOR A SECURITY DOCUMENT AND METHOD OF FORMING SAME

(71) Applicant: LINXENS HOLDING, Mantes la Jolie (FR)

(72) Inventors: Anupont PHAKPING, Bang Pa-In (TH); Sarawut CHANTHAWEE, Bang Pa-In (TH); Jakaphan JAIYEN, Bang Pa-In (TH); Jirapa POUNGLOOK-IN, Bang Pa-In (TH)

(21) Appl. No.: 19/139,129

(22) PCT Filed: Dec. 14, 2023
(86) PCT No.: PCT/IB2023/000742

§ 371 Date: Jun. 13, 2025

(30) Foreign Application Priority Data
Dec. 16, 2022 (EP) 22306917.0

(51) Int. Cl. G06K 19/077; B32B 3/30; B32B 7/12; B32B 27/36

(52) U.S. Cl. CPC G06K 19/07722; B32B 3/30; B32B 7/12; B32B 27/365; B32B 2307/402; B32B 2307/412; B32B 2307/414; B32B 2307/7376; B32B 2425/00

(57) ABSTRACT

The present invention refers to a pre-laminated structure for a smart card and/or a data page for a security document comprising a core structure comprising one or more core layers, a first layer formed on one side of the core structure and having a first cutout portion, a second layer formed on the opposite side of the core structure and having a second cutout portion aligned with the first cutout portion, and an inlay portion inserted into the second cutout portion. According to the invention, the second layer has a first thickness and the inlay portion has a second thickness and a ratio between the second thickness and the first thickness is larger than 1. The pre-laminated structure for a smart card and/or a data page for a security document is advantageously provided with an optical pattern. The present invention also discloses a method for forming said pre-laminated structure for a smart card and/or a data page for a security document.

### RELATED APPLICATIONS

This application claims priority to International Application No. PCTIB2023/000742, filed Dec. 14, 2023, which claims priority to European Patent Application No. 22 306 917.0, filed Dec. 16, 2022, the contents of which are incorporated by reference herein in their entireties.

### FIELD OF THE INVENTION

The present invention relates to a pre-laminated structure of a smart card, a smart card, a method of forming a pre-laminated structure of a smart card, and a method of forming a smart card.

### STATE OF THE ART

Smart cards, or identification cards, are increasingly used for making financial transactions, providing access to premises, and allowing identification of a smart card holder by integrating personal information into the card, for example. Generally, a smart card comprises means for storing and transmitting data, optionally also for receiving data and/or processing stored and/or transmitted data. The transmittance and/or reception of data may be contactless using an electromagnetic field and/or involve one or more contacts provided in a surface of a smart card. Therefore, a smart card may be considered as being part of a complex system, the smart card interacting with entities within the complex system via one or more interfaces depending on an intended application of the smart card. An example of an interface is given by a card terminal of contact type, contactless type or of a mixture of both types. In any case, a smart card generally includes at least one integrated circuit module comprising at least one of a memory module, a processor module and an antenna module.

Since a smart card is the only component that a user commonly has in hands, there is an ongoing task of developing multifunctional cards that combine functions associated to various types of applications, into a single smart card. Several standards have been developed for smart cards of contact-type, contactless type or hybrid type. These standards specify stringent requirements on the structure and performance of a smart card and its components. In particular, the relevant ISO/IEC standards are especially significant for smart cards because these standards are based on a broad international consensus and define the fundamental properties of smart cards such that smart cards are compatible with a great number of card terminals in all over the world. Therefore, the relevant ISO/IEC standards are to be strictly observed in any smart card fabrication process in order to ensure that fabricated smart cards comply with the relevant ISO/IEC standards. The person skilled in the art is thus assumed to be aware of the relevant ISO/IEC standards and to take them into account when developing smart cards.

On the other hand, data pages for security documents are commonly used for storing sensitive data or information in a permanent and tamper resistant manner, even in combination with electronically stored data. Typically, the data pages for security documents have to provide for resistance of the stored information with respect to environmental influences, while, nevertheless, allowing frequent and long term use of a respective security document. For example, a passport may have to be typically used for a time period of several years and may, thus, depending on the habits of the passport owner, require a more or less frequent opening and closing, storing in sometimes harsh environments and the like.

Moreover, in addition to mechanical robustness, the information included in a corresponding data page for a security document has to provide for high tamper resistance so as to make difficult any intentional manipulation of the information stored in the respective data page of the security document, while, preferably, upon attempting to manipulate the data page, any such attempt should become recognizable in a visible or any other appropriate manner.

Since the various requirements imposed on a data page for a security document are frequently mutually contradictive, as, for instance, frequent use of a passport requires highly flexible materials, which typically offer reduced durability and the like, great efforts have been or are currently being made in order to provide appropriate materials and manufacturing techniques for fabricating data pages of security documents with high robustness against many types of influences and high durability, while also providing a high level of security with respect to the tampering of sensitive data. To this end, plastic materials, in particular, polycarbonate, have been identified as viable candidates for fabricating data pages of security documents.

As both smart cards and data pages for security documents contain sensible information of their holder and/or grant authorization for their holder, it is important to equip smart cards and data pages with security features that allow to protect a smart card and/or a data page against unintended access to its functions, as well as to make a smart card and/or a data page safe against fraud and forgery. For example, “window” features are included into current identity cards for protecting an identity card against forgery and/or manipulation. Basically, a window is punched out during the fabrication process and a security pattern is provided in the void of the window. After filling the remaining void of the window with an appropriate cover, the card is exposed to hot lamination, fusing the material together into a monolithic card body of the smart card and/or data page under fabrication. In case of manipulation of the “window” feature, the integrity of the “window” feature is damaged. Therefore, “window” features represent security features that allow to optically inspect the validity or authenticity of a smart card and/or a data page, which is particularly useful for smart identity cards.

Conventionally, these “window” features require a piece of material to be inserted as an inlay into the void of the window in order to fill the void. In this way, formation of voids and air pockets is avoided. For example, voids and air pockets may reduce the mechanical robustness of a smart card and/or a data page. However, preparing and inserting inlays into voids and air pockets add complexity to the fabrication process of a smart card and/or a data page with “window” feature due to the small dimensions of the inlays and complicated insertion and handling processes of such inlays, thereby increasing fabrication costs.

### SUMMARY

The above issues of conventional smart cards and/or data pages for security documents with “window” features are overcome by a pre-laminated structure for a smart card and/or for a data page, a smart card and/or a data page for security documents, and a method of forming same as defined in the appended set of claims.

According to a first aspect of the present invention, a pre-laminated structure for a smart card and/or for a data page for a security document is provided, the pre-laminated structure comprising:
a core structure comprising one or more core layers;
a first layer formed on one side of the core structure and having a first cutout portion;
a second layer formed on the opposite side of the core structure and having a second cutout portion aligned with the first cutout portion; and
an inlay portion inserted into the second cutout portion,
wherein the second layer has a first thickness d and the inlay portion has a second thickness D and a ratio between the second thickness D and the first thickness d is larger than 1.

The advantages of the pre-laminated structure for a smart card and/or for a data page according to the present invention and of the corresponding fabrication method are that handling and assembling of the inlay to be inserted into the corresponding window are optimized and simplified. In fact, the thicker inlay is easier to handle by the user.

Moreover, the smart card and/or the data page for a security document according to the present invention are advantageous because they are easy to assemble and fabricate and they have a flat external surface.

In the present disclosure, the expression “pre-laminated structure” as used herein is understood as representing a pre-laminated body with multiple layers of an insulating material, such as PVC, PC or some other appropriate thermoplastic polymer, which multiple layers are pre-laminated together. Such a pre-laminated body may be considered as representing an intermediate product obtained during fabrication of a smart card. For example, an illustrative pre-laminated structure may be obtained by fusing together different layers of a thermoplastic material into a single homogeneous sheet body, thereby forming a monolithic substrate body. In some illustrative examples of a pre-laminated structure, the substrate body (or base substrate) may have at least one contact and/or interconnection embedded therein, optionally with one or more electronic modules integrated into the substrate body in electric connection with at least one contact and/or interconnection of the substrate body.

In the present disclosure, it is to be understood that the expression “a second cutout portion aligned with the first cutout portion” indicates that a projection of at least a plurality of the points of a cross-section of the first cutout portion (i.e. some or all the points of the cross-section of the first cutout portion) is comprised, or falls within, a cross-section of the second cutout portion. Accordingly, several configurations may be possible, wherein the first and the second cutout portions are considered aligned according to the definition of the present disclosure. For instance, a symmetric configuration may be possible, wherein a cross-section of the first cutout portion is equal to a cross-section of the second cutout portion, so that all the points of the cross-section of the first cutout portion may be projected onto the cross-section of the second cutout portion. For example, an asymmetric configuration may be possible, wherein the cross-section of the first cutout portion differs from the cross-section of the second cutout portion, e.g. the cross-section of the first cutout portion is larger or smaller than the cross-section of the second cutout portion, so that part of the points of the cross-section of the first cutout portion may be projected onto the cross-section of the second cutout portion.

### BRIEF DESCRIPTION OF THE DRAWINGS

The present invention will be explained in detail with regard to the accompanying drawings in which:

FIG. 1 schematically illustrates a side view of a pre-laminated structure for a smart card and/or for a security document according to an embodiment of the present invention;

FIG. 2 schematically illustrates a side view of a pre-laminated structure for a smart card and/or for a security document according to another embodiment of the present invention;

FIG. 3 schematically illustrates a side view of a pre-laminated structure for a smart card and/or for a security document according to another embodiment of the present invention;

FIG. 4 schematically illustrates a side view of a smart card and/or a data page for a security document according to an embodiment of the present invention;

FIG. 5 schematically illustrates a step of a method for forming a pre-laminated structure for a smart card and/or for a security document according to an embodiment of the present invention;

FIG. 6 schematically illustrates a side view of a pre-laminated structure for a smart card and/or for a security document according to another embodiment of the present invention;

FIG. 7 schematically illustrates a side view of a pre-laminated structure for a smart card and/or for a security document according to another embodiment of the present invention;

FIG. 8 schematically illustrates a side view of a pre-laminated structure for a smart card and/or for a security document according to another embodiment of the present invention.

### DETAILED DESCRIPTION

The description of the present disclosure has been presented for purposes of illustration and description, but is not intended to be exhaustive or limited to the disclosure in the form disclosed. The scope of the present disclosure is defined in the appended set of claims. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated. Finally, those fields considered known to the skilled person will not be described to avoid covering in a useless way the described invention.

In the present disclosure, expressions such as “top”, “bottom”, “up”, “down”, “right”, “left”, “central” and variations thereof refer to the orientation of the pre-laminated structure and of the smart card or data page for a security document shown in the illustrative embodiments of the Figures, but they should not be intended as limiting the present invention to a predefined orientation of the pre-laminated structure and of the smart card.

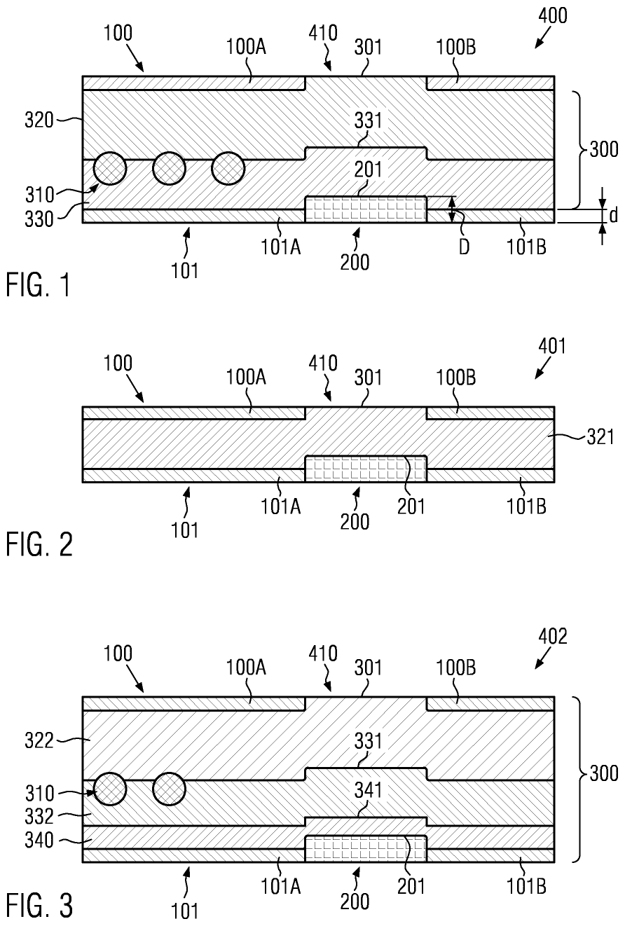

FIG. 1 schematically illustrates a cross-sectional view of a pre-laminate structure for a smart card 400, according to an embodiment of the present invention.

A pre-laminated structure is typically provided in the form of a layer stack that includes two or more individual material sheets or layers which may allow insertion of one or more inlays carrying desired information or data into the stacked structure. The data or information may then be “encapsulated” in the stacked structure after performing a respective lamination process.

In the illustrative embodiment of FIG. 1, the pre-laminated structure 400 comprises a plurality of individual material layers 100, 320, 330, 101, whose optical characteristics may be adapted with respect to the overall requirements and may impart a desired optical pattern to the pre-laminated structure 400. The inner layers 320 and 330 form the core 300 of the pre-laminated structure 400 comprising the relevant electronic components of the smart card. The core structure 300 comprises, for instance, an antenna 310 for enabling wireless communication for the smart card.

As shown in FIG. 1, the top layer 100 comprises a cutout portion, which is filled with a corresponding material of the core layer 320 that is laminated to the top layer 100. In a similar way, the bottom layer 101 comprises a cutout portion, wherein an inlay portion 200 is placed.

In the embodiment of FIG. 1, the top layer 100 comprises a first portion 100A that has a first optical appearance, a second portion 301 that has a second optical appearance and a third portion 100B that has a third optical appearance. Preferably, the first portion 100A and the third portion 100B have the same optical appearance. In the embodiment of FIG. 1, the bottom layer 101 comprises a first portion 101A that has a fourth optical appearance, a second portion or inlay portion 200 that has a fifth optical appearance and a third portion 101B that has a sixth optical appearance. Preferably, the first portion 101A and the third portion 101B have the same optical appearance. In a preferred configuration, the first portion 100A of the top layer 100, the first portion 101A of the bottom layer 101, the third portion 100B of the top layer 100 and the third portion 101B of the bottom layer 101 have the same optical appearance.

In the present disclosure, it is understood that the expression “optical appearance” indicates an optical response of a specific material to an incident radiation, wherein the term “optical” refers in particular to an incident radiation having a wavelength in the range of 200 nm to 1000 nm. For example, the optical appearance may be determined by a predefined parameter, such as light transmittance, absorbance, and/or reflectivity and the like, wherein respective values of the predefined parameters that define the optical appearance of a specific material or portion may be determined on the basis of same test conditions or environmental conditions so that different parameter values obtained during the specific conditions represent an explicit indication of a specific optical appearance.

In a preferred embodiment, the portions 100A and 100B of the top layer 100 and the portions 101A and 101B of the bottom layer 101 may be substantially opaque with respect to light of the visible range, thereby hiding any underlying areas of the pre-laminated structure 400. For example, the portions 100A and 100B of the top layer 100 and the portions 101A and 101B of the bottom layer 101 may be made of a specific base material, such as polycarbonate or other equivalent plastic materials, provided with predefined colorants and the like so as to have a predefined opaque color. The predefined color may be any color, for instance white.

In the preferred embodiment of FIG. 1, the optical appearance of the inlay portion 200 of the bottom layer 101 is different from the optical appearance of the portions 101A and 101B, thereby resulting in a specific optical pattern of the bottom layer 101. The optical pattern of the bottom layer 101 depends on the optical appearance, size, shape and position of the inlay portion 200 with respect to the portions 101A and 101B.

In the embodiment of FIG. 1, the inlay portion 200 is positioned within the layer 101 so as to be laterally surrounded by the portions 101A and 101B, thereby forming a “window” in the bottom layer 101. According to the invention, the optical appearance of the second portion 200 corresponds to an increased transmittance, at least in the visible range, compared to the portions 101A and 101B, so that the portion 200 provides a transparent or translucent window in the pre-laminated structure 400. Preferably, the second portion 200 may comprise a color changeable material, that is a material which changes color depending on the orientation with respect to the incident light.

It should be appreciated that, even if the portions 101A, 101B and 200 have different optical appearances, such as different optical transmittance for light radiation in the visible range, these portions may be made of the same base material, such as polycarbonate.

The first and third portions 101A and 101B of the bottom layer 101 have a first thickness d and the second portion 200 has a second thickness D, wherein the thickness indicates the dimension of the portions 101A, 200 and 101B along the stacking direction of the pre-laminated structure 400. According to the present invention, the second thickness D of the second portion 200 is larger than the first thickness d of the portions 101A and 101B, so that a ratio between the second thickness D and the first thickness d is larger than 1. Preferably, a ratio between the second thickness D and the first thickness d is comprised in the range between 1 and 3, wherein the upper limit, i.e. 3, is included in the range. The advantage of this configuration is that the inlay portion 200 is thicker than the bottom layer 101 and can be easily handled by an operator during assembling procedures.

Despite the different thicknesses, the portions 101A, 200 and 101B of the bottom layer 101 are flush with one another along the external surface of the pre-laminated structure 400 in the configuration of FIG. 1, so as to form a flat external surface for the pre-laminated structure 400. Accordingly, in view of the different thicknesses, the portions 101A, 200 and 101B are not flush with each other along the internal surface facing the core layers 300. Hence, along the internal surface of the bottom layer 101 facing the core layers 300, a stepped surface is formed, wherein the inlay portion 200 forms a protruding portion 201 that is fitted into a corresponding recess in the core 300 of the pre-laminated structure 400. The method for inserting the inlay portion 200 and forming the pre-laminated structure 400 will be described below with reference to FIG. 5.

In the preferred embodiment of FIG. 1, the optical appearance of the second portion 301 of the top layer 100 is different from the optical appearance of the first and third portions 100A and 100B, thereby resulting in a specific optical pattern of the top layer 100. The optical pattern of the top layer 100 depends on the optical appearance, size, shape and position of the second portion 301 with respect to the portions 100A and 100B. The second portion 301 of the top layer 100 corresponds to a protruding portion of the inner layer 320 of the pre-laminated structure 400, which is placed below the top layer 100 and is laminated thereto.

Essentially, the same criteria described for the inlay portion 200 in combination with the portions 101A and 101B of the bottom layer 101 apply also to the portion 301 in combination with the portions 100A and 100B of the top layer 100.

In an illustrative embodiment, the optical appearance of the second portion 301 of the top layer 100 is substantially the same as the optical appearance of the second portion 200 of the bottom layer 101, thereby imparting the same optical appearance to the pre-laminated structure 400 when viewed from a front side or a back side thereof. In other illustrative embodiments, the optical appearances of the portions 301 and 200 may differ from each other, thereby providing superior flexibility in adjusting the overall optical appearance of the pre-laminated structure 400. For example, the portions 301 and 200 may differ from each other in terms of transmittance, color, response to visible and/or non-visible radiation.

In a preferred embodiment, the second portion 301 of the top layer 100 and the second portion 200 of the bottom layer 101 may be aligned along the stacking direction and may be made of a transparent or translucent material, so as to form a transparent or translucent window 410 in the pre-laminated structure 400. In other words, in a preferred embodiment, the portions 301 and 200 enable seeing through the pre-laminated structure 400.

In the illustrative embodiment of FIG. 1, the pre-laminated structure 400 further comprises two inner layers 320 and 330 positioned, with respect to the stacking direction, between the top layer 100 and the bottom layer 101. The thickness, lateral size and/or shape of the layers 320 and 330 may be adapted so as to comply with the overall requirements of the pre-laminated structure 400.

The layers 320 and 330 are laminated together along a contact surface. As shown in FIG. 1, the contact surface is a stepped surface, wherein a protruding portion 331 of the layer 330 is fitted into a corresponding recess of the layer 320.

As will be clear from the below disclosure of the method for forming the pre-laminated structure 400, according to the present invention, a thickness of the protruding portion 331 of the layer 330 along the stacking direction is substantially equal to a thickness of the protruding portion of the layer 320 forming the second portion 301 of the top layer 100 and to a thickness of the protruding portion 201 of the inlay portion 200. The value of this thickness corresponds to the difference between the value of the second thickness D of the second portion 200 and the value of the first thickness of the portions 101A and 101B of the bottom layer 101.

In an illustrative embodiment, the optical appearance of the protruding portion 331 of the core layer 330 is substantially the same as the optical appearance of the protruding portion 201 of the second portion 200. In other illustrative embodiments, the optical appearances of the portions 331 and 201 may differ from each other, thereby providing superior flexibility in adjusting the overall optical appearance of the pre-laminated structure 400. For example, the portions 331 and 201 may differ from each other in terms of transmittance, color, response to visible and/or non-visible radiation.

In a preferred embodiment, at least a central portion of the layers 320 and 330, which is aligned with the portions 301 and 200 of the top and bottom layers 100, 101 along the stacking direction, has a predefined transmittance in the visible range so as to enable seeing through the pre-laminated structure 400. In other words, in a preferred configuration, the second portion 301 of the top layer 100, the central portions of the layers 320 and 330 and the second portion 200 of the bottom layer may be transparent and/or translucent so as to form a see-through window 410 in the pre-laminated structure 400. This configuration may be advantageous in the context of security documents that require image data identification, while still ensuring a high degree of tamper resistance. For example, an image of the owner of the smart card or any other relevant symbol or token may be placed in correspondence of the see-through window 410 of the pre-laminated structure and may be easily identified by a human eye and/or an image recognition system. For example, an image or an ink feature may be provided on one or more of the portions 301, 331, 201, or 200 and may be visible by a user through the corresponding window 410.

FIG. 2 schematically shows a pre-laminated structure 401 for a smart card according to an alternative embodiment of the present invention, wherein the core 300 of the pre-laminated structure comprises a single layer 321. As illustrated in FIG. 2, the core layer 321 comprises a protruding portion 301 which is visible from the top of the pre-laminated structure 401. Moreover, the core layer 321 accommodates the inlay portion 200 in a corresponding recess.

FIG. 3 schematically shows a pre-laminated structure 402 for a smart card according to an alternative embodiment of the present invention, wherein the core 300 of the pre-laminated structure comprises three core layers 322, 332 and 340, i.e. it comprises the additional core layer 340 with respect to the embodiment of FIG. 1. As illustrated in FIG. 3, the core layer 322 comprises a protruding portion 301 which is visible from the top of the pre-laminated structure 402. Moreover, in the embodiment of FIG. 3, the core layer 332 comprises a protruding portion 331 and the additional core layer 340 comprises a protruding portion 341.

In the pre-laminated structure 401 and 402 of FIGS. 2 and 3, the top layer 100 and the bottom layer 101 correspond to the top layer 100 and the bottom layer 101 described with reference to FIG. 1.

It is clear that, even if only configurations wherein the core 300 for the pre-laminated structure comprises one, two or three core layers have been disclosed, the core 300 may comprise any number of layers, for instance four or more.

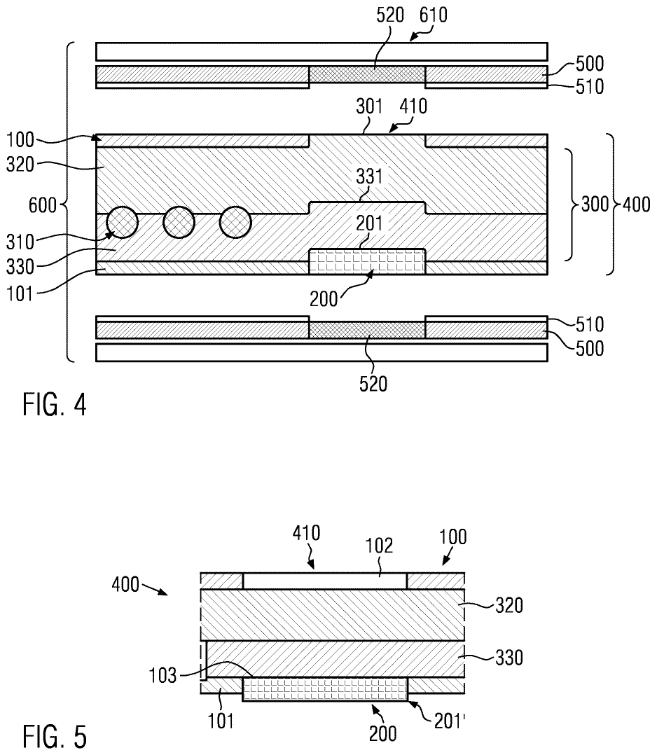

FIG. 4 schematically illustrates a cross-sectional view of a smart card 600, according to an embodiment of the present invention.

The smart card 600 comprises a pre-laminated structure 400, 401, 402 according to one or more of the embodiments described above.

On each of the top and bottom layers 100 and 101 of the pre-laminated structure 400, one or more additional layers 500, 510 may be formed. For example, at least two additional layers 510 and 500 may be formed on the top layer 100 of the pre-laminated structure 400. Similarly, at least two additional layers 510 and 500 may be formed on the bottom layer 101 of the pre-laminated structure.

According to an embodiment of the present invention, the additional layer 500 may be formed of a transparent and/or translucent material, such as transparent and/or translucent PC and/or transparent and/or translucent PVC, and the additional layer 510 may be formed of an opaque material and may comprise printed features, so as to form an opaque printed layer. According to an alternative embodiment of the present invention, the additional layer 510 may be formed of a transparent and/or translucent material, such as transparent and/or translucent PC and/or transparent and/or translucent PVC, and the additional layer 500 may be formed of an opaque material and may comprise printed features, so as to form an opaque printed layer. Accordingly, the additional layers 500 and 510 may form an overlay comprising a transparent sheet with an opaque sheet with printed features on it.

Each of the additional layers 500, 510 for the top layer 100 of the pre-laminated structure 400 may comprise a recess portion and the recess portions may be aligned to each other along a stacking direction, so that, when the two additional layers are laminated together, a top cutout portion is formed. In a similar way, each of the additional layers 500, 510 for the bottom layer 101 of the pre-laminated structure 400 may comprise a recess portion and the recess portions may be aligned to each other, so that, when the two additional layers are laminated together, a bottom cutout portion is formed.

Each of the top and bottom cutout portions may be filled with an inlay portion 520. The inlay portion 520 may be formed of a transparent and/or translucent material, such as transparent and/or translucent PC and/or transparent and/or translucent PVC. The inlay portion 520 may have a thickness equal to and may be made of the same material as the transparent sheet 500 or 510 of the overlay formed by the additional layers. In other words, if the additional layer 500 is formed of a transparent and/or translucent material, the inlay portion 520 has a thickness equal to the thickness of the additional layer 500; if the additional layer 510 is formed of a transparent and/or translucent material, the inlay portion 520 has a thickness equal to the thickness of the additional layer 510. Preferably, the inlay portion 520 is added during formation of the final smart card and it comprises predefined security features for the smart card. For instance, the inlay portion 520 may be added by the customer during formation of the final smart card and may require predefined security features required by the customer.

According to a preferred embodiment, the inlay portions of the smart card 520 may be aligned with the see-through window 410 of the pre-laminated structure 400, so as to form an overall window 610 extending completely through a thickness of the smart card 600 and enabling seeing through same.

A method for forming the pre-laminated structure 400, 401, 402 or 403 according to an embodiment of the present invention is described below. It is to be understood that the method described below can be carried out for obtaining a pre-laminated structure according to any of the disclosed embodiments.

As a first step, the core layers 320 and 330 are attached to each other so as to form the core structure 300. Subsequently, the top layer 100, already provided with a cutout portion 102, is attached to a top surface of the core layer 320 by any appropriate means, such as adhesion enhancing agents, mechanical attachments means and the like. Moreover, the bottom layer 101, already provided with a cutout portion 103, is attached to a bottom surface of the core layer 330 by any appropriate means, such as adhesion enhancing agents, mechanical attachments means and the like.

The cutout portion of the bottom layer 101 corresponds in position, size and shape to the inlay portion 200.

As a later step, which is schematically illustrated in FIG. 5, an appropriate fill material is prepared and inserted into the cutout portion 103 of the bottom layer 101, thereby providing the desired material characteristics and optical appearance for the inlay portion 200, as previously discussed. The fill material or portion 200 may be attached to the bottom layer 101 by any appropriate means, such as mechanical attachment, adhesion agents and the like. On the other hand, no fill material is inserted into the cutout portion 102 of the top layer 100.

As described above, a thickness D of the inlay portion 200 is larger than a thickness d of the portions 101A and 101B of the bottom layer 101. Accordingly, when the inlay portion 200 is inserted into the cutout portion of the bottom layer 101, part of the inlay portion 201′ protrudes therefrom (see FIG. 5).

At this stage, the inlay portion 200 is further pushed by means of appropriate means, so as to be completely inserted into the cutout portion 103 of the bottom layer 101. For instance, the insertion means may induce melting of the inlay portion 200 to facilitate insertion. As a consequence of the inlay portion 200 being pushed into the cutout portion 103 of the bottom layer 101, the inlay portion 200 is partially inserted and fitted into the core layer 330. Accordingly, the core layer 330 deforms: a recess forms in correspondence of the protruding portion 201 of the inlay portion 200 fitted into the core layer 330 and a protruding portion 331 forms in the core layer 330. The deformation extends through all the layers of the pre-laminated structure 400. In fact, because of the formation of the protruding portion 331 in the core layer 330, the core layer 320 is also deformed and a protruding portion 301 is formed also in the core layer 320.

Finally, the protruding portion 301 of the core layer 320 occupies the gap of the cutout portion 102 of the top layer 100. Since the cutout portion 102 has not been filled with any filling material and/or insert, the protruding portion 301 can be accommodated into the cutout portion 102 without producing further deformations in the pre-laminated structure 400. Preferably, the size and shape of the cutout portion 102 are designed so that they can accommodate the protruding portion 301 formed during the pre-lamination process.

In other words, as a consequence of the inlay portion 200 being inserted into the cutout portion 103 of the bottom layer 101, the whole pre-laminated structure 400 is initially modified, to compensate for the difference in thickness between the inlay portion 200 and the cutout portion 103 of the bottom layer 101. After this initial deformation, the pre-laminated structure 400 is flattened on both sides and has flat surfaces on both the top and bottom layers 100 and 101. The inlay portion 200 is completely fitted into the core structure 300. Therefore, the pre-laminated structure 400 may be laminated to the additional layers 500, 510 to form the smart card 600.

Preferably, the additional layers 500, 510 may be attached to the corresponding layers 100, 101 of the pre-laminated structure 400 and an accordingly formed stacked body configuration may be subjected to a thermal lamination process such as a hot lamination.

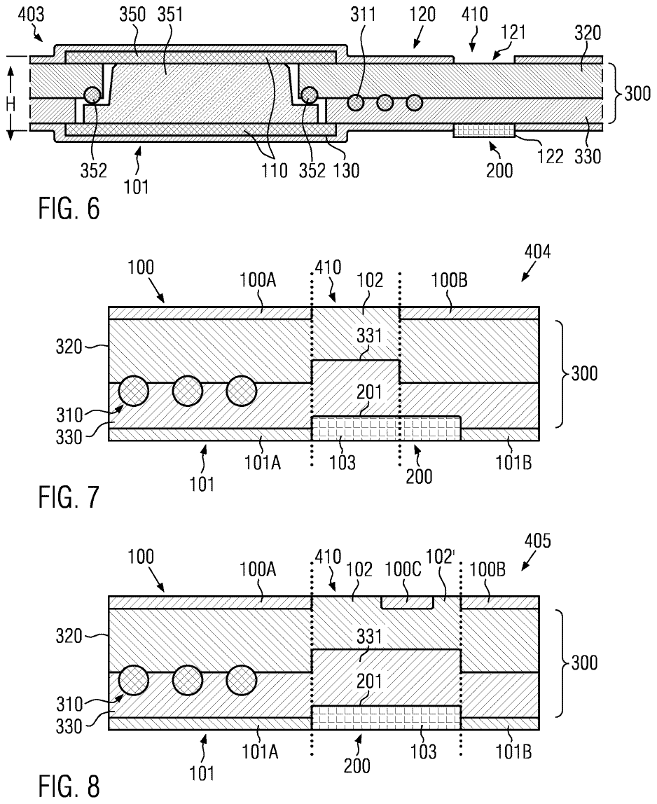

FIG. 6 schematically illustrates a cross-sectional view of a pre-laminated structure 403, according to an alternative embodiment of the present invention.

The pre-laminated structure 403 of FIG. 6 comprises a core body 303 including two or more layers 320, 330 and further comprises an electronic module 350. It is clear that, even if the core body 303 of FIG. 6 comprises two layers 320, 330, it may correspond to the core body 300 according to any one of the previous embodiments.

The electronic module 350 is embedded into the core layer 330 and it may comprise a chip module 351 and a module antenna 311 realized as a coil embedded into the core layer 330. The chip module 351 may be embedded into the core layer 330 in accordance with known techniques, e.g. by recessing the core layer 330 and accommodating the chip module 351 into the recess, as well as bonding the chip module 351 to contact lines (not illustrated) routed in the core layer 330 for electrically coupling the chip module 351 and the module antenna 311. Furthermore, bonding pads 352 forming a mechanical and/or electrical coupling to the chip module 351, may be present.

The electronic module 350 is sandwiched between two adhesive layers 110, which are made, for instance, by AC conductive paste.

Two overlay sheets 120 and 130 are formed at opposing sides of the core body 303 and are attached to the electronic module 350 by means of the adhesive layers 110. For example, the top overlay sheet 120 may be formed on an upper surface of the core body 303, while the bottom overlay sheet 130 may be formed on a bottom surface of the core body 303. The top overlay sheet 120 may correspond to the top layer 100 described above and the bottom overlay sheet 130 may correspond to the bottom layer 101 described above.

The overlay sheet 120 may have one recess 121 formed therein. In a similar way, the overlay sheet 130 may have one recess 122 formed therein.

According to the embodiment shown in FIG. 6, the recess 122 of the bottom overlay sheet 130 is filled with an inlay portion 200, as described above. In particular, the inlay portion 200 may be transparent or translucent or may comprise a color changeable material. In the embodiment of FIG. 6, the inlay portion 200 may have any predefined shape, for instance a geometrical shape, such as a circle or a rectangle, or a complex shape, such as a star, a world map, or a country map.

As shown in the embodiment of FIG. 6, the bottom overlay sheet 130 has a first thickness d that is smaller than a second thickness D of the inlay portion 200. Accordingly, the inlay portion 200 initially slightly protrudes from the bottom overlay sheet 130. During the pre-lamination process, the inlay portion 200 is then inserted into the bottom overlay sheet 130 as described for the method above. At the end of this process, the inlay portion 200 is flush with the bottom overlay sheet 130 along the bottom surface and the pre-laminated structure 403 comprises a flat bottom surface, which can be laminated to the other layers of the smart card.

On the other hand, the recess 121 of the top overlay sheet 120 is not filled with any material. As a consequence of the insertion of the inlay portion 200 inside the recess 122, the recess 121 is filled with material of the core layer 320 as described above, thus resulting in a flat top surface, which can be laminated to the other layers of the smart card.

The recess 121 of the top overlay sheet 120 is aligned with the recess 122 of the bottom overlay sheet 130 filled with the inlay material 200. The area of the core body 303 in correspondence of the inlay material 200 is advantageously made of transparent or translucent material, so that a see-through window 410 is formed in the pre-laminated structure 403 and the inlay 200 can be seen from the top of the final smart card.

FIG. 7 schematically illustrates a side view of a pre-laminated structure 404 for a smart card and/or for a security document according to an alternative embodiment of the present invention.

In the pre-laminated structure 404 of FIG. 7, the cutout portion 103 formed in the bottom layer 101 (accommodating the inlay portion 200) and the cutout portion 102 formed in the top layer 100 are asymmetric. In particular, in the embodiment of FIG. 7, the cutout portion 102 of the top layer is smaller than the cutout portion 103 of the bottom layer 101.

According to an alternative embodiment (not shown), the cutout portion of the top layer may be larger than the cutout portion of the bottom layer 101.

The inlay 200 is inserted into the cutout portion 103 of the bottom layer 101 of the pre-laminated structure 404 according to the methods described above with reference to the pre-laminated structures 400, 401, 402, and 403.

With continued reference to FIG. 8, since the cross-section of the cutout portion 102 of the top layer 100 is smaller than the cross-section of the cutout portion 103 of the bottom layer 101 accommodating the inlay 200, a portion of the inlay 200 is covered by the portion 100B of the top layer 100. In particular, in the configuration of FIG. 8, a portion of the inlay 200 is covered only by the portion 100B of the top layer 100.

It is to be understood that, according to an alternative configurations (not shown), the cutout portions 102 and 103 may be designed so that a portion of the inlay 200 is covered only by the portion 100A of the top layer 100, or it is partially covered by both portions 100A and 100B of the top layer 100.

In this way, the see-through window 410 formed in the pre-laminated structure 404 enables seeing only part of the inlay portion 200, that is only the part completely aligned with the cutout portion 102 of the top layer 100 and not covered by the portions 100A and/or 100B of the top layer 100.

It is to be understood that, even if in the schematic representation of FIG. 7, two core layers are shown, the core structure 300 may comprise any number of layers, for instance one, three, four, or more.

FIG. 8 schematically illustrates a side view of a pre-laminated structure 405 for a smart card and/or for a security document according to an alternative embodiment of the present invention.

The configuration of the pre-laminated structure 405 of FIG. 8 is similar to the one of the pre-laminated structure 405 shown in FIG. 1. Accordingly, the pre-laminated structure 405 of FIG. 8 comprises two core layers 320, 330, laminated between a top layer 100 and a bottom layer 101. Preferably, the contact surface between the two core layers 320, 330 is a stepped surface, wherein a protruding portion 331 of the layer 330 is fitted into a corresponding recess of the layer 320.

In the configuration of FIG. 8, the top layer 100 is advantageously provided with two cutout portions 102 and 102′. In this way, the top layer 100 is divided into three portions 100A, 100B, and 100C. During manufacturing of the pre-laminated structure 405, the material of the core layer 320 fills the cutout portions 102, 102′, thus creating a predefined optical pattern.

In the present disclosure, the optical pattern indicates a sequence of portions of the core structure 300 and of the top layer with predefined optical features, such as transparency, translucency, or opaqueness.

For instance, the core layer 320 may be made of a transparent or translucent material, and the top layer 100 may be made of an opaque or white material. In this way, the optical pattern of the upper side of the pre-laminated structure 405 may be characterized by a sequence of opaque/white portions of the top layer 100 and transparent/translucent portions of the core layer 320.

Preferably, the first and the second cutout portions 102, 102′of the top layer 100 may be designed so that the portion of the top layer 100C separating them has reduced dimensions. For instance, the cross-section of the separating portion 100C may be smaller than the cross-section of the inlay portion 200; preferably the cross-section of the separating portion 100C may be less than half of the cross-section of the inlay portion 200. In this way, the separating portion 100C does not entirely cover the inlay portion 200. Accordingly, a portion of the inlay 200 may be still visible from the upper side of the pre-laminated structure 405 through the see-through window 410.

It is to be understood that, even if in the configuration of FIG. 8 it is shown that the core structure 300 comprises two core layers 320, 330, the core structure 300 may comprise any number of layers, for instance one, three, four, or more.

Furthermore, even if FIG. 8 discloses that the cutout portion 103 formed in the bottom layer 101 is shaped and/or positioned so that its edges are perfectly aligned with corresponding edges of the cutout portion 102 and of the additional cutout portion 102′ formed in the top layer 100, this configuration should not be intended as limiting the present invention. In fact, according to alternative configurations (not shown), the cutout portion 103 may be shaped and/or positioned so that its edges are not perfectly aligned with corresponding edges of the cutout portion 102 and of the additional cutout portion 102′ formed in the top layer 100. For instance, other configurations may be possible, wherein only one edge of the cutout portion 103 is perfectly aligned with a corresponding edge of the cutout portion 102 or of the additional cutout portion 102′, or wherein no edges of the cutout portion 103 are aligned with the edges of the cutout portion 102 or of the additional cutout portion 102′.

Moreover, in the present disclosure, it is to be understood that the cutout portions 102, 102′ and/or 103 may have any shape, for instance the shape of a polygon, such as a regular or irregular polygon, or a circular shape, or a complex shape, such as the shape of an objection, the profile of a world map, a country map, or the like. In this way, the pre-laminated structure may carry predefined information and/or security features.

The method for forming the pre-laminated structure 405 of FIG. 8 is similar to the methods disclosed above for forming the pre-laminated structures 400, 401, 402, 403.

As a first step, the core layers 320 and 330 are attached to each other so as to form the core structure 300. Subsequently, the top layer 100, already provided with the cutout portions 102 and 102′, is attached to a top surface of the core layer 320 by any appropriate means, such as adhesion enhancing agents, mechanical attachments means and the like. Moreover, the bottom layer 101, already provided with a cutout portion 103, is attached to a bottom surface of the core layer 330 by any appropriate means, such as adhesion enhancing agents, mechanical attachments means and the like.

The cutout portion of the bottom layer 101 corresponds in position, size and shape to the inlay portion 200.

As a later step, an appropriate fill material is prepared and inserted into the cutout portion 103 of the bottom layer 101, thereby providing the desired material characteristics and optical appearance for the inlay portion 200, as previously discussed. The fill material or portion 200 may be attached to the bottom layer 101 by any appropriate means, such as mechanical attachment, adhesion agents and the like. On the other hand, no fill material is inserted into the cutout portions 102 and 102′of the top layer 100.

As described above, a thickness D of the inlay portion 200 is larger than a thickness d of the portions 101A and 101B of the bottom layer 101. Accordingly, when the inlay portion 200 is inserted into the cutout portion 103 of the bottom layer 101, part of the inlay portion 201′ protrudes therefrom.

At this stage, the inlay portion 200 is further pushed by means of appropriate means, so as to be completely inserted into the cutout portion 103 of the bottom layer 101. For instance, the insertion means may induce melting of the inlay portion 200 to facilitate insertion. As a consequence of the inlay portion 200 being pushed into the cutout portion 103 of the bottom layer 101, the inlay portion 200 is partially inserted and fitted into the core layer 330. Accordingly, the core layer 330 deforms: a recess forms in correspondence of the protruding portion 201 of the inlay portion 200 fitted into the core layer 330 and a protruding portion 331 forms in the core layer 330. The deformation extends through all the layers of the pre-laminated structure 400. In fact, because of the formation of the protruding portion 331 in the core layer 330, the core layer 320 is also deformed and a protruding portion is formed also in the core layer 320.

Finally, the protruding portion of the core layer 320 occupies the gap of the two cutout portions 102 and 102′ of the top layer 100. Since the cutout portions 102 and 102′ have not been filled with any filling material and/or insert, the protruding portion can be accommodated into the cutout portions 102 and 102′ without producing further deformations in the pre-laminated structure 405.

In other words, as a consequence of the inlay portion 200 being inserted into the cutout portion 103 of the bottom layer 101, the whole pre-laminated structure 405 is initially modified, to compensate for the difference in thickness between the inlay portion 200 and the cutout portion 103 of the bottom layer 101. After this initial deformation, the pre-laminated structure 405 is flattened on both sides and has flat surfaces on both the top and bottom layers 100 and 101. The inlay portion 200 is completely fitted into the core structure 300. Therefore, the pre-laminated structure 405 may be laminated to the additional layers 500, 510 to form the smart card 600. In the present detailed description, it has to be understood that, even if reference has been made only to a pre-laminated structure for a smart card and/or to a smart card, and to a method of forming same, the same teachings apply also to a pre-laminated structure for a data page for a security document and/or to a data page for a security document and to the corresponding method.

### LIST OF REFERENCES

100: top layer
100A, 100B, 100C: portions of the top layer
101: bottom layer
101A, 101B: portions of the bottom layer
102, 103, 102′: cutout portion
110: adhesive layer
120, 130: overlay sheet
121, 122: recess in the overlay sheet
200: inlay portion
201, 201′: protruding portion of the inlay portion
300, 303: core structure
301: second portion of the top layer
310: antenna
320, 321, 322, 330, 332, 340: core layers
341: protruding portion with tapering side walls
350: electronic module
351: electronic chip
352: electronic pads
400, 401, 402, 403, 404, 405: pre-laminated structure
410, 610: see-through window
500, 510: additional layers for the smart card
520: smartcard inlay
600: smart card
d: first thickness
D: second thickness
H: thickness of pre-laminated structure

1. A pre-laminated structure for a smart card and/or for a data page for a security document, comprising:
a core structure comprising one or more core layers;
a first layer formed on one side of said core structure and having a first cutout portion;
a second layer formed on the opposite side of said core structure and having a second cutout portion aligned with said first cutout portion and
an inlay portion inserted into said second cutout portion,
wherein said second layer has a first thickness (d) and said inlay portion has a second thickness (D) and a ratio between said second thickness (D) and said first thickness (d) is larger than 1.

2. The pre-laminated structure according to claim 1, wherein said ratio is smaller than or equal to 3, preferably equal to 2.

3. The pre-laminated structure according to claim 1, wherein said second cutout portion is completely aligned with said first cutout portion, so that each line delimiting an edge of said first cutout portion coincides with a corresponding line delimiting a corresponding edge of said second cutout portion.

4. The pre-laminated structure according to claim 1, wherein said second cutout portion is partially aligned with said first cutout portion, so that only part of the points forming a cross-section of said first cutout portion are projected onto a cross-section of said second cutout portion.

5. The pre-laminated structure according to claim 1, wherein said inlay portion is made of a transparent or translucent material.

6. The pre-laminated structure according to claim 1, wherein said inlay portion is made of a color changeable material.

7. The pre-laminated structure according to claim 1, wherein said inlay portion has a different optical appearance with respect to said second layer.

8. The pre-laminated structure according to claim 1, wherein said second layer is opaque or white.

9. The pre-laminated structure according to claim 1, wherein said core structure comprises at least two core layers having a contact surface and said contact surface is a stepped surface comprising a protruding portion.

10. The pre-laminated structure according to claim 9, wherein said protruding portion is aligned with said inlay portion.

11. The pre-laminated structure according to claim wherein said protruding portion has a third thickness equal to a difference between said second thickness (D) and said first thickness (d).

12. The pre-laminated structure according to claim 9, wherein said protruding portion is made of a transparent or translucent material or a color changeable material, so that said inlay portion aligned with said protruding portion is visible from each side of said pre-laminated structure.

13. The pre-laminated structure according to claim 1, wherein said first cutout portion is filled with material of said at least one layer of said core structure.

14. The pre-laminated structure according to claim 13, wherein said material of said at least one layer filling said first cutout portion is transparent and/or translucent, so that said inlay portion is visible from a side of said pre-laminated structure comprising said first layer.

15. The pre-laminated structure according to claim 1, wherein said inlay portion is flush with one side of said second layer opposite to said core structure and forms a protruding portion fitted into said core structure, wherein said protruding portion has a protruding thickness equal to a difference between said second thickness (D) and said first thickness (d).

16. The pre-laminated structure according to claim 1, wherein a cross-section of said first cutout portion is equal to a cross-section of said second cutout portion.

17. The pre-laminated structure according to claim 1, wherein a cross-section of said first cutout portion differs from a cross-section of said second cutout portion, for instance a cross-section of said first cutout portion is larger or smaller than a cross-section of said second cutout portion.

18. The pre-laminated structure according to claim 1, wherein said first layer comprises an additional cutout portion, and a material of said core structure fills said first cutout portion and said additional cutout portion so as to form a predefined optical pattern.

19. A smart card and/or a data page for a security document comprising:
A pre-laminated structure comprising:
a core structure comprising one or more core layers;
a first layer formed on one side of said core structure and having a first cutout portion;
a second layer formed on the opposite side of said core structure and having a second cutout portion aligned with said first cutout portion; and
an inlay portion inserted into said second cutout portion,
wherein said second layer has a first thickness (d) and said inlay portion has a second thickness (D) and a ratio between said second thickness (D) and said first thickness (d) is larger than 1;
At least one transparent layer and an opaque layer with printed features covering one side of said pre-laminated structure
At least one transparent layer and an opaque layer with printed features covering the opposite side of said pre-laminated structure.

20. A method for forming a pre-laminated structure for a smart card and/or a data page for a security document comprising the following steps:
attaching a first layer to a first surface of a core structure, said first layer comprising a first cutout portion;
attaching a second layer to a second opposite surface of said core structure, said second layer comprising a second cut-out portion, wherein said first layer, said second layer and said core structure form a stacked structure and said first and second cut-out portions are aligned along a stacking direction of said stacked structure; and
filling said second cut-out portion with an inlay material,
wherein said second layer has a first thickness (d) and said inlay material has a second thickness (D) and a ratio between said second thickness (D) and said first thickness (d) is larger than 1, so that said inlay material partially protrudes from said second layer, thus defining a protruding portion.

21. The method according to claim 20, further comprising the following step:
Inserting said inlay portion inside said second layer so that said inlay portion is flushed with said second layer along an external surface opposite to said core structure and so that a protruding portion of said inlay portion is formed along an interconnection surface of said second layer with said core structure;
Inducing a deformation of said core structure as a consequence of said insertion, so that said first cutout portion is filled with a portion of material of said at least one layer of said core structure.

22. The method according to claim 21, wherein said first layer (100) comprises an additional cutout portion and, as a consequence of said deformation of said core structure, both said first cutout portion and said additional cutout portion are filled with corresponding portions of material of said at least one layer of said core structure.

23. The method according to claim 20 for obtaining a pre-laminated structure comprising:
a core structure comprising one or more core layers;
a first layer formed on one side of said core structure and having a first cutout portion;
a second layer formed on the opposite side of said core structure and having a second cutout portion aligned with said first cutout portion; and
an inlay portion inserted into said second cutout portion,
wherein said second layer has a first thickness (d) and said inlay portion has a second thickness (D) and a ratio between said second thickness (D) and said first thickness (d) is larger than 1.

24. The method according to claim 20, further comprising the following steps:
Providing at least one transparent layer and at least one opaque layer with printed features on one side of said pre-laminated structure;
Providing at least one transparent layer and at least one opaque layer with printed features on the opposite side of said pre-laminated structure;
Laminating said transparent layers and said opaque layers to said pre-laminated structure.
